(19) United States
(12) Patent Application Publication
(10) Pub. No.: US 2013/0186654 A1
(43) Pub. Date: Jul. 25, 2013

(54) MULTIPLE DISCHARGE FIRE EXTINGUISHING SYSTEM

(71) Applicants: Robert G. Dunster, Burnham (GB); David Frasure, Wilson, NC (US); Daniel Ray MacLachlan, Wilson, NC (US); Paul W. Weller, Cippenham (GB)

(72) Inventors: Robert G. Dunster, Burnham (GB); David Frasure, Wilson, NC (US); Daniel Ray MacLachlan, Wilson, NC (US); Paul W. Weller, Cippenham (GB)

(21) Appl. No.: 13/365,385

(22) Filed: Feb. 3, 2012

(30) Foreign Application Priority Data
Jan. 20, 2012 (EP) 12151977.1

(51) Int. Cl. A62C 3/07

(52) U.S. Cl. 169/62

(57) ABSTRACT

A fire extinguishing system for use in a crew compartment of a ground-based vehicle includes at least two cylinders. The cylinders dispense a fire extinguishing agent through a release mechanism. A control for the overall system is operable to actuate the two cylinders. A nozzle is positioned downstream of the release mechanism to distinguish the extinguishing agent into the crew compartment. The majority of the dispensing from at least a first of the two cylinders occurs in less than five seconds.

### BACKGROUND OF THE INVENTION

This application relates to a fire extinguishing system which is received in a space in a vehicle to extinguish fires and prevent explosions within the space.

Vehicles are often provided with fire extinguishing systems, and in particular with systems which are structured to quickly extinguish flames under any number of conditions. Often aircraft are provided with elaborate extinguishing systems that include long passageways to provide extinguishing materials from a distant source to any number of locations on the aircraft. Aircraft fire extinguishing systems may include a first dispensing cycle which is intended to extinguish a fire, and then an inert gas dispensing mode which occurs for a period of time, until the aircraft can land.

In general, the aircraft extinguishing systems are intended to control a fire until an aircraft can land. Thus, they are provided with long-term dispensing over many minutes, and even hours.

Ground based vehicles have typically been provided with less elaborate fire extinguishing systems. However, and in particular with ground based military vehicles, systems must be provided which are quickly actuated to extinguish a flame.

Thus, it is known to provide a cylinder in a vehicle space, such as a crew compartment, which has automatic fire extinguishing systems deployed after an event is detected. Typically, sensors identify a fire or explosion threat, and include a fast acting release mechanism and nozzle which enables rapid and efficient deployment of an agent throughout the crew compartment.

### SUMMARY OF THE INVENTION

A fire extinguishing system for use in a crew compartment of a ground-based vehicle includes at least two cylinders. The cylinders dispense a fire extinguishing agent through a release mechanism. A control for the overall system is operable to actuate the two cylinders. A nozzle is positioned downstream of the release mechanism to dispense the extinguishing agent into the crew compartment. The majority of the dispensing from at least a first of the two cylinders occurs in less than five seconds.

These and other features of the invention would be better understood from the following specifications and drawings, the following of which is a brief description.

### BRIEF DESCRIPTION OF THE DRAWINGS

FIG. 1 shows a prior art system.

FIG. 2 shows a first inventive system.

FIG. 3 shows a second inventive system.

FIG. 4 illustrates a third embodiment.

FIG. 5 shows yet another embodiment.

FIG. 6 shows another embodiment.

### DETAILED DESCRIPTION

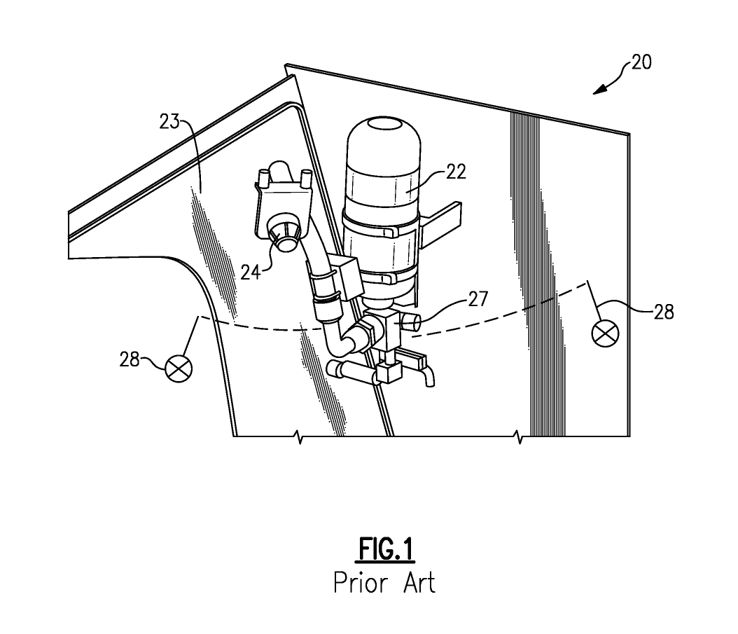

FIG. 1 shows a known system 20 incorporating a cylinder 22 which is received within a crew compartment 23 in a ground based vehicle. A nozzle 24 is associated with a fast acting release mechanism 27. Sensors 28, shown schematically, sense the presence of a fire or explosive risk in the crew compartment 23, and actuate the release mechanism 27 to dispense an agent into the crew compartment. The sensors may be infrared or ultraviolet, as examples.

The dispensing can occur within 30 milliseconds of the detection occurring. The discharge can occur for 50 milliseconds to 1 second, as an example.

The agent will typically suppress or knock down the explosive threat. However, at times, it may be desirable or necessary to have the ability to react to a second event. As an example, and in particular with military vehicles, a crew compartment could be hit a subsequent time. Also, fuel leakage, etc., could re-establish a previously extinguished fire threat.

Thus, as shown in FIG. 2, an inventive system 120 incorporates at least two cylinders 124 and 126 associated with a nozzle 24. A line 180 communicates cylinders 124 and 126 to the nozzle 24. As shown to the right hand side of FIG. 2, it is possible for a third, and even further cylinders to be associated with the system 120.

A control 122 is set to actuate the fast acting release mechanism 123 as necessary. A sensor 121 provides signals to the control 122. The dispensing occurs very rapidly. This is true for all of the embodiments in this application. At least the initial cylinder has the majority of its dispensing occur in less than five seconds, and typically less than 1.5 seconds, and even more typically less than one second. The dispensing can occur much more rapidly, and can be on the order of 50 millisecond.

There may be a time delay between actuation of the cylinders 124 and 126, or the cylinder 126 may be kept in reserve for a subsequent restrike, or the flame restarting. As an example, a military crew compartment could be subject to multiple strikes, such as shells. Also, a flame that had previously been extinguished could increase in magnitude. The reserve cylinder may be actuated in those events. Both subsequent events may be sensed by the sensor 121.

In the FIG. 2 embodiment, both cylinders 124 and 126 are provided generally with the same extinguishing agent. Examples may include but not be limited to BC powder such as potassium bicarbonate (KHCO₃) and sodium bicarbonate (NaHCO₃), or water based agents such as potassium lactate, potassium acetate and plain water may be utilized along with an inert gas or water vapor as optional additions. It can be appreciated that there are many conventional gaseous fire suppression agents that are contemplated including but not limited to 1,1,1,2,3,3,3-heptafluoropropane (i.e., HFC-227ea (e.g., FM200®)), and 1,1,1,2,2,4,5,5,5- nonafluoro-4-(trifluoromethyl)-3-pentanone (i.e., FK-5.1.12 (e.g., Novec 1230®)). In certain cases it may also be advantageous to mix extinguishing agents within the same canister. One such example is the addition of a small mass of BC powder (typically 5-10 wt %) within HFC-227ea.

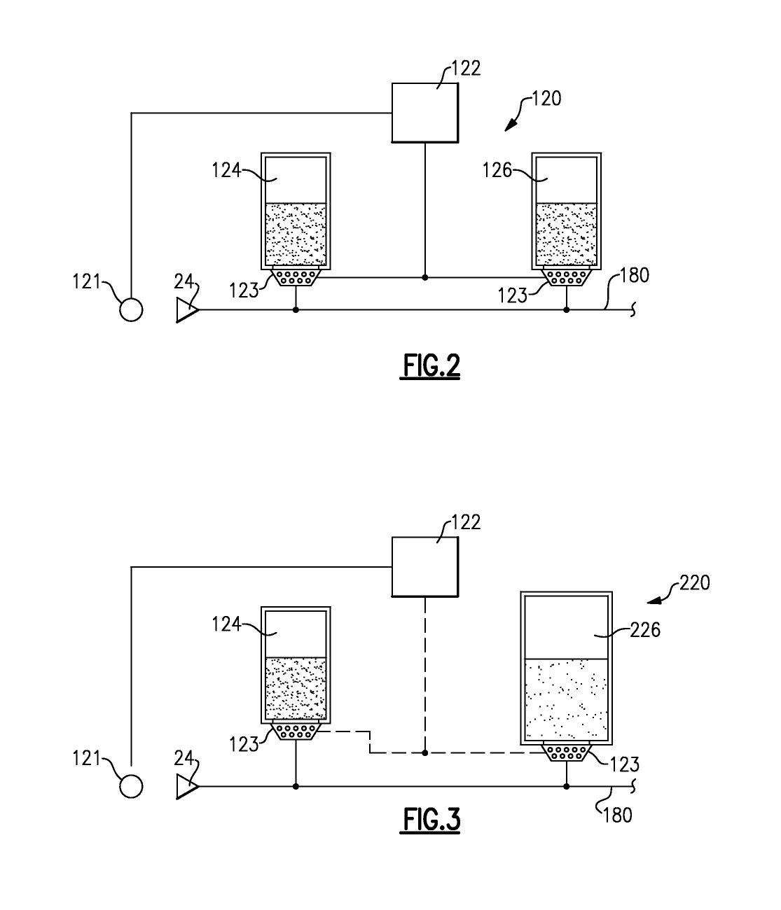

FIG. 3 shows an embodiment which is very similar to FIG. 2, however, in the FIG. 3 embodiment 220, the cylinder 226 is provided with a distinct extinguishing material from that in the cylinder 124. As an example, the cylinder 226 may be provided with a higher percentage of inert gas or water vapor, however, it would also typically be provided with an extinguishing agent such as BC powder. The higher percentage of inert gas or water vapor makes this arrangement better suited to a system wherein the second cylinder is actuated to maintain an inert environment after the flame has been extinguished. The FIG. 2 embodiment might be better suited to systems wherein the second cylinder is only actuated when a subsequent signal is received, such as a restrike or a restarting of the flame.

The FIG. 3 embodiment may be set such that the actuation of the release mechanisms 123 would be simultaneous, but wherein the discharge characteristics would be distinct such that the cylinder 226 would tend to discharge later.

However, the control as utilized in the FIG. 2 embodiment may also be incorporated into this embodiment, wherein there is a time delay, or there may be a requirement for a restrike for actuation of the secondary cylinder.

FIG. 4 shows an embodiment 320 wherein a single body incorporates the cylinders 124 and 326. The control 322 still controls the single release mechanism 325 based upon signals from a sensor 121. The release mechanism 325 distributes the material from both cylinders 124 and 326 through the common nozzle 24. This embodiment may have a passage closed by a seal or membrane 324 which may be pierced in some manner to allow the fire extinguishing material from the cylinder 326 to pass through the release mechanism 325. The actuation of the membrane or other seal at 324 can be time delayed relative to the distribution from the cylinder 124, or may be utilized with the requirement of a restrike or restart of the flame.

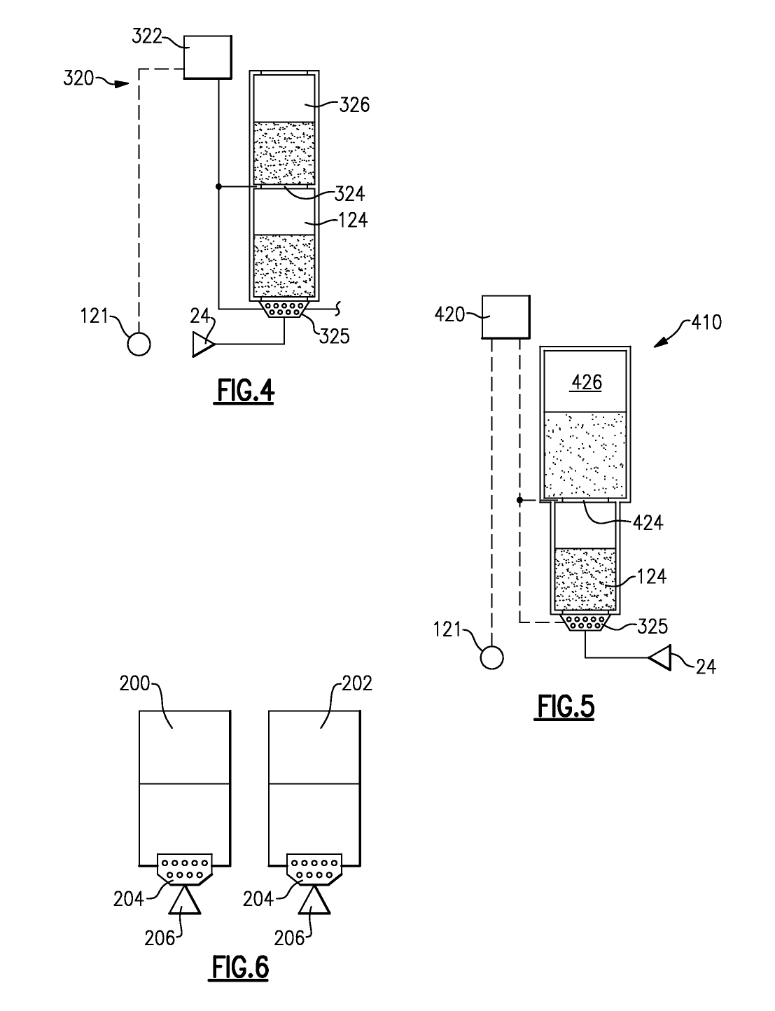

FIG. 5 shows an embodiment 410 having a control 420. The system may be otherwise as shown in FIG. 4, with a membrane or other seal 424 between the cylinders 426 and 124. The FIG. 5 embodiment differs from the FIG. 4 embodiment in much the same way as the FIGS. 2 and 3 embodiments differ, namely with regard to the extinguishing materials in the cylinders 326 and 426.

FIG. 6 shows another embodiment wherein each cylinder 200, 202 is provided with its own nozzle 206 associated with the release mechanism 204. It should be understood that this arrangement can be used with any of the embodiments shown in FIGS. 2-5. In addition, some small conduit can be placed between the nozzle 206 and the release mechanism 204.

Across all of the embodiments, it is expected and preferred that the nozzles 24 (or 206) be positioned to be within three meters of the cylinders. More preferably, the nozzle should be within one meter of these cylinders.

While some fire suppressant agents and inert materials have been disclosed above, any combination of agents and materials which are acceptable under current environmental regulations may be utilized. As an example, insert gases such as nitrogen or Argon, or CO₂ up to 3 vol % may be used. Water-based agents may be in liquid and/or vapor form. Additives such as alkali salts (e.g., potassium bicarbonate, potassium acetate, potassium lactate, etc.) or foams (e.g., AFFF), and finally dry chemicals (e.g., sodium bicarbonate, potassium bicarbonate, Monnex™) may be utilized.

In addition, if a delay is desired between the actuation of the second cylinder and the first, the initiation time may be controlled. A fast electronic/pyrotechnic initiator can be utilized for the main cylinder, followed by a slower electronic or pyrotechnic initiator, or a gas generator which would take a longer period of time to actuate to initiate the secondary cylinder. Again, the amount of the delay would be controlled as desired. A difference in mass flow and discharge time can also be achieved between the two cylinders by varying the outlet diameter, and the volume of the cylinders, respectively.

In summary, the embodiments of this invention disclose systems where in a single system placed in a crew compartment is capable of multiple dispensing of fire extinguishing materials. A worker of ordinary skill in the art would recognize that modifications will come within the scope of this invention. For that reason, the following claims should be studied to determine the true scope and content of this invention.

1. A fire extinguishing system for use in a crew compartment of a ground based vehicle comprising:
at least two cylinders to be placed in a crew compartment, said cylinders dispensing a fire extinguishing agent through at least one release mechanism, said release mechanism being controlled by a control for the overall system, and said control being operable to actuate the two cylinders; and
a nozzle positioned downstream of said release mechanism to dispense the extinguishing agent into the vehicle compartment, and the majority of the dispensing from a first of said at least two cylinders occurring in five seconds or less.

2. The system as set forth in claim 1, wherein said two cylinders are two separate cylinders.

3. The system as set forth in claim 2, wherein each of said two separate cylinders has a separate one of said release mechanism.

4. The system as set forth in claim 3, wherein a single nozzle receives extinguishing material from both of said cylinders downstream of said release mechanisms.

5. The system as set forth in claim 1, wherein each of said first and second cylinders include at least one fire extinguishing agent, and an inerting agent.

6. The system as set forth in claim 1, wherein said each of first and second cylinders is provided within a single canister.

7. The system as set forth in claim 6, wherein said single canister includes a separate seal between the first and second cylinders, with said control controlling said seal to allow fluid to flow from said second cylinder.

8. The system as set forth in claim 1, wherein the first and second cylinders are actuated simultaneously, but with distinct discharge characteristics.

9. The system as set forth in claim 1, wherein a time delay is included between actuation of said first cylinder and said second cylinder.

10. The system as set forth in claim 1, wherein a subsequent signal is required before said second cylinder is actuated.

11. The system as set forth in claim 10, wherein said subsequent signal is at least one of a sensed indication that a vehicle including the crew compartment has been struck again, or the flame has increased in magnitude since the dispensing of the first cylinder.

12. The system as set forth in claim 1, wherein said first cylinder includes a greater percentage of fire extinguishing material relative to inert material compared to a similar percentage in said second cylinder.

13. The system as set forth in claim 1, wherein the majority of the dispensing from at least the first of the at least two cylinders occurs in one second or less.

14. The system as set forth in claim 1, wherein said nozzle is positioned to be within less than three meters of said at least two cylinders.

15. The system as set forth in claim 1, wherein said nozzle is positioned to be within one meter of both of said at least two cylinders.

16. The system as set forth in claim 14, wherein said nozzle includes a separate nozzle associated with each of said cylinders, and said separate nozzles are within three meters of an associated one of said at least two cylinders.
